(19) United States
(12) Patent Application Publication
(10) Pub. No.: US 2024/0284455 A1
(43) Pub. Date: Aug. 22, 2024

(54) CONTROL RESOURCE SET AND PHYSICAL DOWNLINK CONTROL CHANNEL PUNCTURING

(71) Applicant: QUALCOMM Incorporated, San Diego, CA (US)

(72) Inventors: Le LIU, San Jose, CA (US); Jae Ho RYU, San Diego, CA (US); James BECKMAN, La Jolla, CA (US); Alberto RICO ALVARINO, San Diego, CA (US); Javier RODRIGUEZ FERNANDEZ, San Diego, CA (US)

(21) Appl. No.: 18/441,861

(22) Filed: Feb. 14, 2024

Related U.S. Application Data
(60) Provisional application No. 63/485,758, filed on Feb. 17, 2023.

(51) Int. Cl. H04W 72/1273; H04L 1/00; H04L 5/00; H04W 72/0453

(52) U.S. Cl. CPC H04W 72/1273; H04L 1/0068; H04L 5/0051; H04W 72/0453

(57) ABSTRACT

Various aspects of the present disclosure generally relate to wireless communication. In some aspects, a user equipment (UE) may receive a control resource set (CORESET) configuration indicating puncturing associated with a CORESET to be received in a transmission bandwidth, wherein the puncturing indicates at least one of a quantity of resource blocks in a frequency domain allocated for the CORESET, an index of one or more punctured RBs in the frequency domain, a quantity of physical downlink control channel (PDCCH) symbols in the CORESET, a resource element group (REG)-bundle size associated with the CORESET, or a PDCCH precoding configuration associated with the CORESET. The UE may receive the CORESET in the transmission bandwidth based at least in part on the puncturing indicated by the CORESET configuration. Numerous other aspects are described.

### CROSS-REFERENCE TO RELATED APPLICATION

This patent application claims priority to U.S. Provisional Patent Application No. 63/485,758, filed on Feb. 17, 2023, entitled “CONTROL RESOURCE SET AND PHYSICAL DOWNLINK CONTROL CHANNEL PUNCTURING,” and assigned to the assignee hereof. The disclosure of the prior Application is considered part of and is incorporated by reference into this patent Application.

### FIELD OF THE DISCLOSURE

Aspects of the present disclosure generally relate to wireless communication and to techniques and apparatuses for control resource set (CORESET) and physical downlink control channel (PDCCH) puncturing.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a control resource set (CORESET) configuration indicating puncturing associated with a CORESET to be received in a transmission bandwidth, where the puncturing indicates at least one of a quantity of resource blocks (RBs) in a frequency domain allocated for the CORESET, an index of one or more punctured RBs in the frequency domain, a quantity of physical downlink control channel (PDCCH) symbols in the CORESET, a resource element group (REG)-bundle size associated with the CORESET, or a PDCCH precoding configuration associated with the CORESET. The method may include receiving the CORESET in the transmission bandwidth based at least in part on the puncturing indicated by the CORESET configuration.

Some aspects described herein relate to a method of wireless communication performed by a network node. The method may include transmitting a CORESET configuration indicating puncturing associated with a CORESET to be received in a transmission bandwidth, where the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET. The method may include transmitting the CORESET in the transmission bandwidth based at least in part on the puncturing configuration.

Some aspects described herein relate to a UE for wireless communication. The UE may include one or more memories and one or more processors coupled to the one or more memories. The one or more processors may be configured to receive a CORESET configuration indicating puncturing associated with a CORESET to be received in a transmission bandwidth, where the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET. The one or more processors may be configured to receive the CORESET in the transmission bandwidth based at least in part on the puncturing indicated by the CORESET configuration.

Some aspects described herein relate to a network node for wireless communication. The network node may include a one or more memories and one or more processors coupled to the one or more memories. The one or more processors may be configured to transmit a CORESET configuration indicating puncturing associated with a CORESET to be received in a transmission bandwidth, where the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET. The one or more processors may be configured to transmit the CORESET in the transmission bandwidth based at least in part on the puncturing indicated by the CORESET configuration.

Some aspects described herein relate to a non-transitory computer-readable medium that stores a set of instructions for wireless communication by a UE. The set of instructions, when executed by one or more processors of the UE, may cause the UE to receive a CORESET configuration indicating puncturing associated with a CORESET to be received in a transmission bandwidth, where the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET. The set of instructions, when executed by one or more processors of the UE, may cause the UE to receive the CORESET in the transmission bandwidth based at least in part on the puncturing indicated by the CORESET configuration.

Some aspects described herein relate to a non-transitory computer-readable medium that stores a set of instructions for wireless communication by a network node. The set of instructions, when executed by one or more processors of the network node, may cause the network node to transmit a CORESET configuration indicating puncturing associated with a CORESET to be received in a transmission bandwidth, where the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET. The set of instructions, when executed by one or more processors of the network node, may cause the network node to transmit the CORESET in the transmission bandwidth based at least in part on the puncturing indicated by the CORESET configuration.

Some aspects described herein relate to an apparatus for wireless communication. The apparatus may include means for receiving a CORESET configuration indicating puncturing associated with a CORESET to be received in a transmission bandwidth, where the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET. The apparatus may include means for receiving the CORESET in the transmission bandwidth based at least in part on the puncturing indicated by the CORESET configuration.

Some aspects described herein relate to an apparatus for wireless communication. The apparatus may include means for transmitting a CORESET configuration indicating puncturing associated with a CORESET to be received in a transmission bandwidth, where the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET. The apparatus may include means for transmitting the CORESET in the transmission bandwidth based at least in part on the puncturing indicated by the CORESET configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of an impact of the use of a comparatively smaller transmission bandwidth on communication of a physical downlink control channel (PDCCH).

FIGS. 5A-5E are diagrams illustrating examples associated with control resource set (CORESET) and PDCCH puncturing, in accordance with aspects of the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

A wireless communication system may be designed with a minimum transmission bandwidth that can be used for transmission and reception of a communication. However, it may be desirable to support transmission and reception of communications using a comparatively smaller transmission bandwidth. For example, a New Radio (NR) system may be designed with a minimum transmission bandwidth of 5 megahertz (MHz) with 24 resource blocks (RBs) in frequency range 1 (FR1) (e.g., with 15 kilohertz (kHz) subcarrier spacing). In such a system, it may be desirable to support wireless communication using a transmission bandwidth in FR1 that is smaller than 5 MHz, such as 3 MHz (e.g., to reduce radio resource usage, improve network efficiency, or the like).

However, with the comparatively smaller transmission bandwidth (e.g., maximum transmission bandwidth of 15 RBs or 16 RBs for a 3 MHz channel bandwidth), larger aggregation levels (ALs) associated with communication of a physical downlink control channel (PDCCH) may not be supported when using legacy control channel element (CCE)-to-resource element group (REG) mapping, which can result in PDCCH detection performance loss.

Some techniques and apparatuses described herein enable CORESET and PDCCH puncturing. In some aspects, a network node may transmit, and a UE may receive, a puncturing configuration associated with a CORESET to be received in a transmission bandwidth. In some aspects, the puncturing configuration may indicate, for example, a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET. The network node may then transmit, and the UE may receive, the CORESET in the transmission bandwidth based at least in part on the puncturing configuration.

In this way, the CORESET (e.g., a PDCCH transmitted in the CORESET) may be punctured so that the CORESET is within the transmission bandwidth, thereby improving PDCCH performance detection and, more generally, improving reliability of PDCCH communication. Additional details are provided below.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

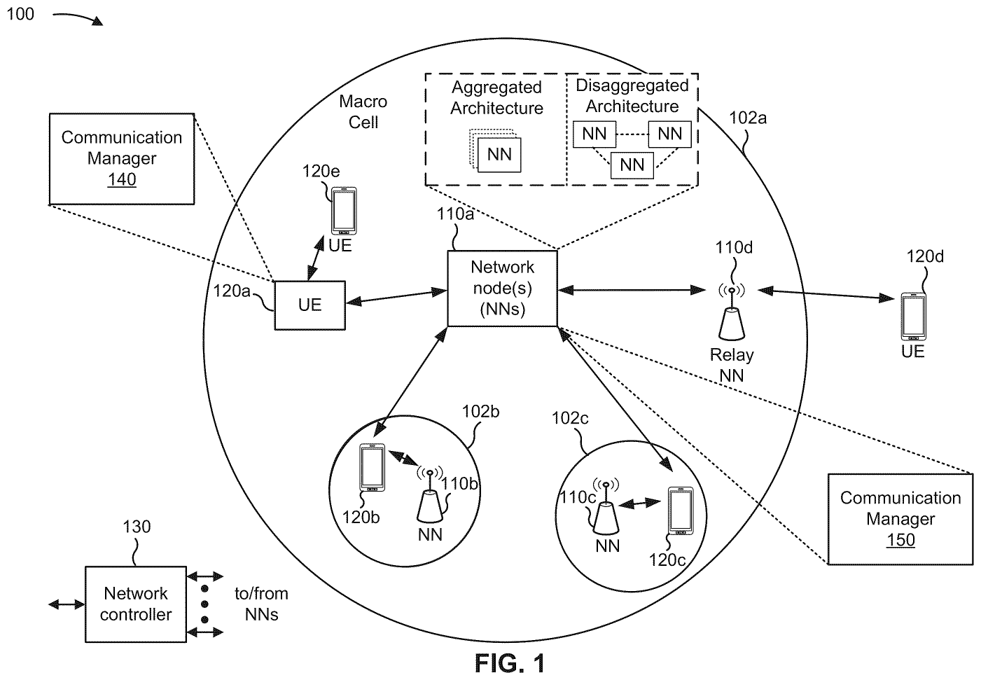

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., one or more memories) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a control resource set (CORESET) configuration indicating puncturing associated with a CORESET to be received in a transmission bandwidth, wherein the puncturing indicates at least one of a quantity of RBs in a frequency domain allocated for the CORESET, an index of one or more punctured RBs in the frequency domain, a quantity of physical downlink control channel (PDCCH) symbols in the CORESET, a resource element group (REG)-bundle size associated with the CORESET, or a PDCCH precoding configuration associated with the CORESET; and receive the CORESET in the transmission bandwidth based at least in part on the puncturing indicated by the CORESET configuration. Additionally, or alternatively, the communication manager 140 may perform one or more other operations described herein.

In some aspects, the network node 110 may include a communication manager 150. As described in more detail elsewhere herein, the communication manager 150 may transmit a CORESET configuration indicating puncturing associated with a CORESET to be received in a transmission bandwidth, wherein the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET; and transmit the CORESET in the transmission bandwidth based at least in part on the puncturing indicated by the CORESET configuration. Additionally, or alternatively, the communication manager 150 may perform one or more other operations described herein.

As indicated above, FIG. 1 is provided as an example. Other examples may differ from what is described with regard to FIG. 1.

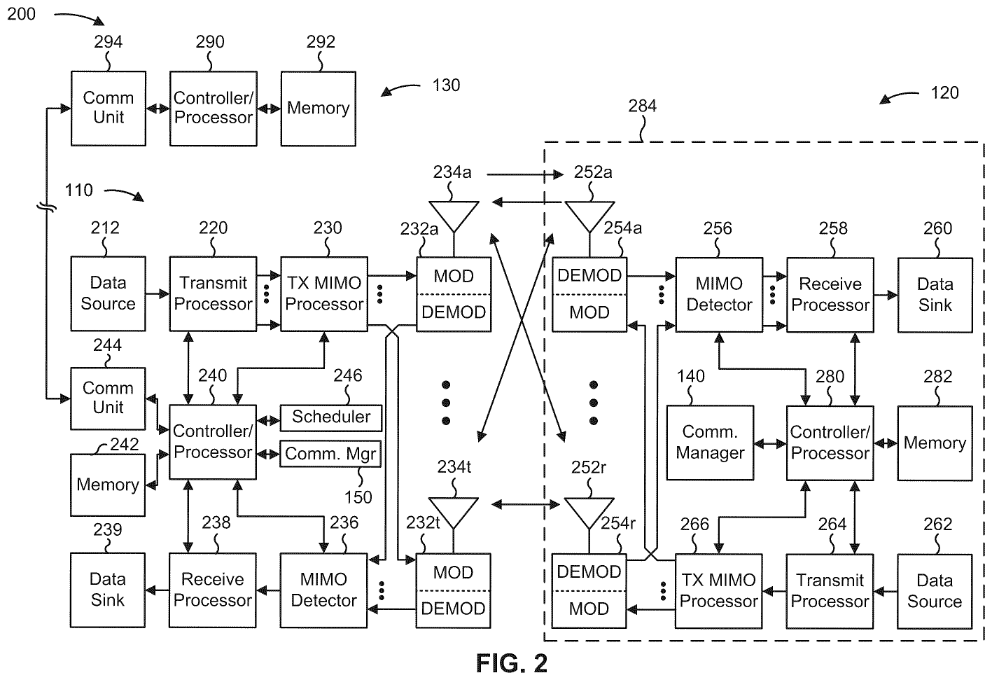

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

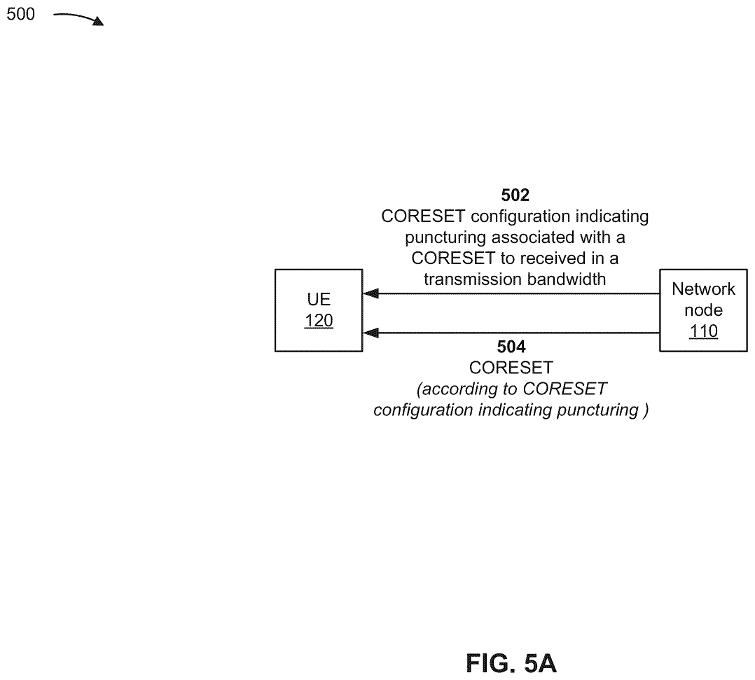

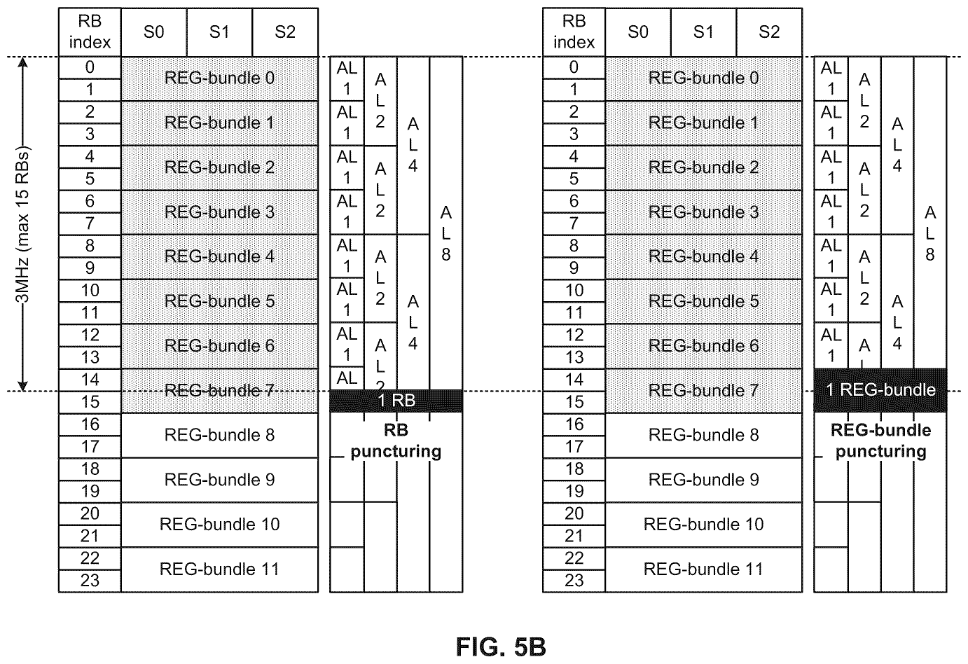

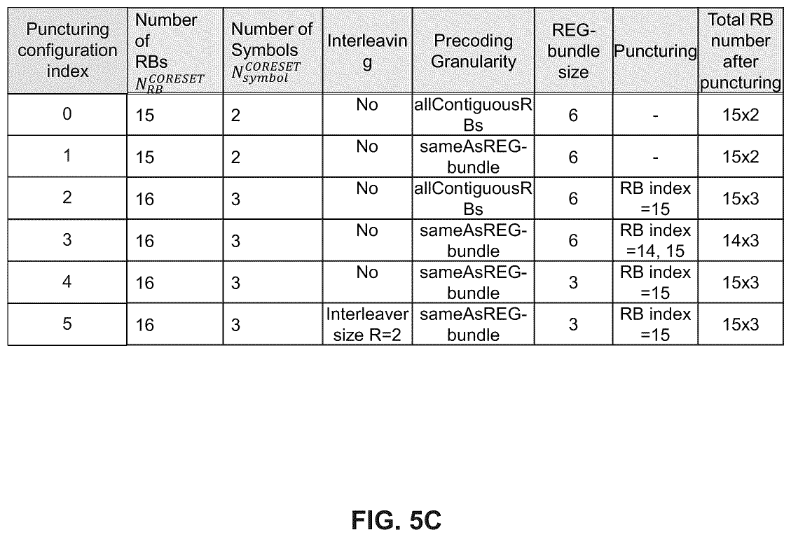

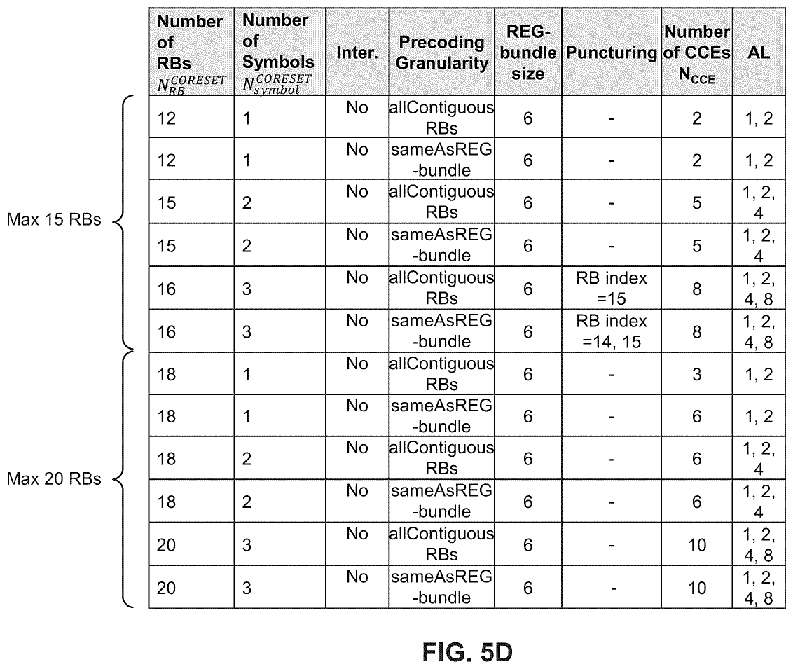

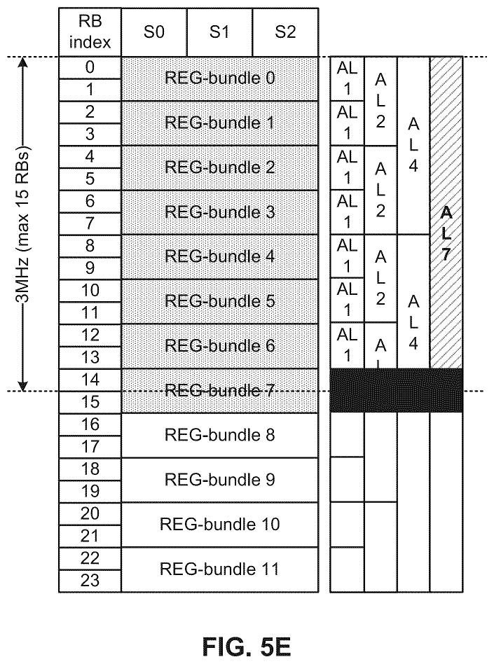

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-9).

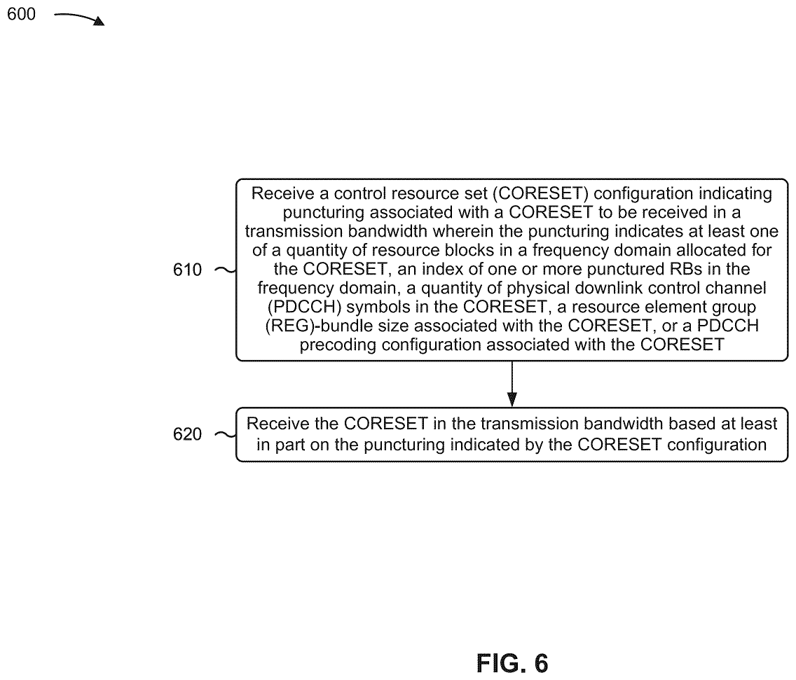

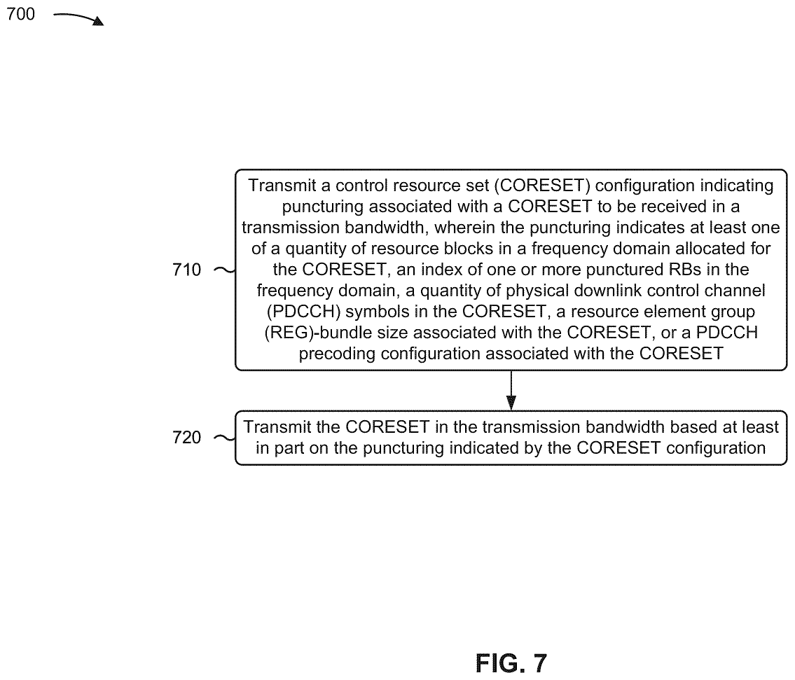

The controller/processor 240 of the network node 110, the controller/processor 280 of the UE 120, and/or any other component(s) of FIG. 2 may perform one or more techniques associated with CORESET and PDCCH puncturing, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE 120 includes means for receiving a CORESET configuration indicating puncturing associated with a CORESET to be received in a transmission bandwidth, wherein the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET; and/or means for receiving the CORESET in the transmission bandwidth based at least in part on the puncturing indicated by the CORESET configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node 110 includes means for transmitting a CORESET configuration indicating puncturing associated with a CORESET to be received in a transmission bandwidth, wherein the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET; and/or means for transmitting the CORESET in the transmission bandwidth based at least in part on the puncturing indicated by the CORESET configuration. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

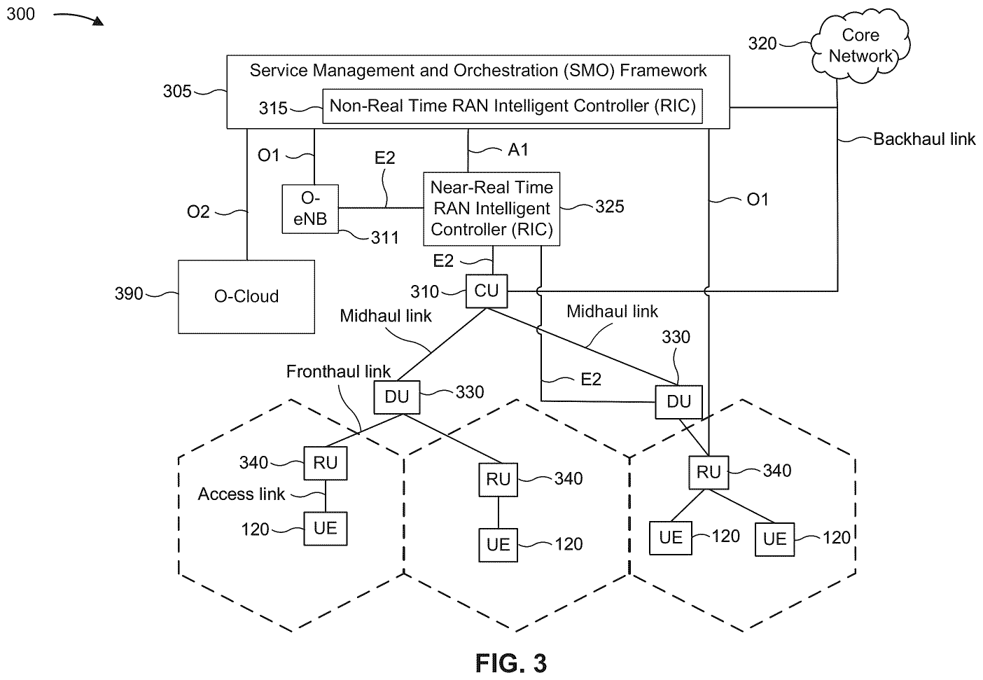

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A wireless communication system may be designed with a minimum transmission bandwidth that can be used for transmission and reception of a communication. However, it may be desirable to support transmission and reception of communications using a comparatively smaller transmission bandwidth. For example, an NR system may be designed with a minimum transmission bandwidth of 5 megahertz (MHz) with 24 resource blocks (RBs) in frequency range 1 (FR1) (e.g., with 15 kilohertz (kHz) subcarrier spacing). In such a system, it may be desirable to support wireless communication using a transmission bandwidth in FR1 that is smaller than 5 MHz, such as 3 MHz (e.g., to reduce radio resource usage, improve network efficiency, or the like). Such a communication may be referred to as a narrowband communication.

However, with the comparatively smaller transmission bandwidth (e.g., maximum transmission bandwidth of 15 RBs or 16 RBs for a 3 MHz channel bandwidth), larger aggregation levels (ALs) associated with communication of a PDCCH may not be supported when using legacy control channel element (CCE)-to-REG mapping, which results in PDCCH detection performance loss.

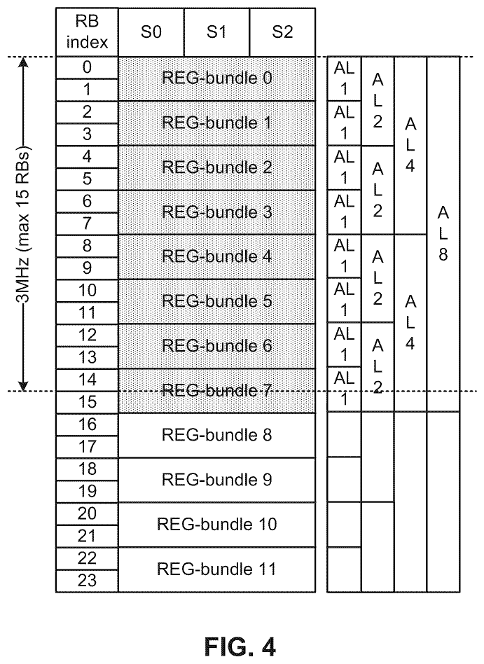

FIG. 4 is a diagram illustrating an example of an impact of the use of a comparatively smaller transmission bandwidth on communication of a PDCCH. The example shown in FIG. 4 is for a transmission bandwidth with a maximum transmission bandwidth of 15 RBs in a 3 MHz channel bandwidth. Thus, a CORESET (e.g., a set of resources in which a PDCCH communication is to be communicated) in this example can be communicated using a maximum transmission bandwidth of 15 RBs in the 3 MHz channel bandwidth. Further, the example shown in FIG. 4 is for a 3-symbol (S0, S1, S2) PDCCH, with an REG-bundle size of 6 (e.g., 6 REGs per REG-bundle). In the 3 MHz channel bandwidth, a legacy synchronization signal (SS)/physical broadcast channel (PBCH) block with 20 RBs may be punctured into 15 RBs. The offset from the smallest RB index (e.g., RB index 0) of the CORESET to the smallest RB index of the common RB overlapping with the first RB of the corresponding SS/PBCH block after puncturing is equal to zero.

However, as illustrated in FIG. 4, a quantity of RBs in the CORESET may be configured such that the quantity of RBs in the CORESET is larger than the transmission bandwidth. This may be the case because one REG-bundle with a size L is the basic unit for PDCCH interleaving and precoding, with a CCE comprising a quantity of REG-bundles equal to 6/L. As a result, as shown in FIG. 4, an RB or an REG-bundle may be at least partially outside of the transmission bandwidth. Therefore, a network node that is to transmit the CORESET, and a UE that is to receive the CORESET, should be configured such that the RB or REG-bundle that is at least partially outside of the transmission bandwidth is handled in a way so as to reduce PDCCH detection performance loss.

Some techniques and apparatuses described herein enable CORESET and PDCCH puncturing. In some aspects, a network node may transmit, and a UE may receive, a puncturing configuration associated with a CORESET to be received in a transmission bandwidth. In some aspects, the puncturing configuration may indicate, for example, a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET. The network node may then transmit, and the UE may receive, the CORESET in the transmission bandwidth based at least in part on the puncturing configuration. In this way, the CORESET (e.g., a PDCCH transmitted in the CORESET) may be punctured so that the CORESET is within the transmission bandwidth, thereby improving PDCCH performance detection and, more generally, improving reliability of PDCCH communication. Additional details are provided below.

FIGS. 5A-5E are diagrams illustrating examples associated with CORESET and PDCCH puncturing, in accordance with aspects of the present disclosure. As shown in FIG. 5A, an example 500 includes communication between a network node 110 and a UE 120. In some aspects, the network node 110 and the UE 120 may be included in a wireless network, such as a wireless network 100. The network node 110 and the UE 120 may communicate via a wireless access link, which may include an uplink and a downlink.

As shown at reference 502 in example 500, the network node 110 may transmit, and the UE 120 may receive, a CORESET configuration indicating puncturing associated with a CORESET to be received in a transmission bandwidth. The CORESET configuration indicating puncturing is a configuration that indicates a manner in which the CORESET is to be punctured (e.g., such that the information is carried in the punctured portion of the CORESET). Such a CORESET configuration is herein referred to as a puncturing configuration. In some aspects, the CORESET configuration may be, for example, a configuration for CORESET 0 (e.g., such that CORESET 0 is to be punctured according to the puncturing indicated by the CORESET configuration).

In some aspects, the puncturing configuration indicates that RB-level puncturing is to be applied to the CORESET. That is, the puncturing configuration may in some aspects indicate that one or more RBs of the CORESET that are at least partially outside of the transmission bandwidth are to be punctured. Alternatively, the puncturing configuration may indicate that REG-bundle-level puncturing is to be applied to the CORESET. That is, the puncturing configuration may indicate that one or more REG-bundles of the CORESET that are at least partially outside of the transmission bandwidth are to be punctured. Thus, if a configured quantity of RBs (e.g., in a frequency domain) in the CORESET is greater than a quantity of RBs in the transmission bandwidth, then the puncturing configuration may be used in association with puncturing of the CORESET, with the puncturing configuration indicating that an RB or an REG-bundle of the CORESET that is at least partially outside of the transmission bandwidth is to be punctured.

FIG. 5B illustrates examples of CORESET puncturing. In the examples shown in FIG. 5B, a 3-symbol PDCCH with an REG-bundle size of 6 is to be transmitted in a 3 MHz channel bandwidth with maximum transmission bandwidth of 15 RBs. The left diagram in FIG. 5B illustrates an example of RB-level puncturing. As shown in the left diagram, an RB with RB index 15 is outside of the transmission bandwidth and, therefore, may be punctured according to the puncturing configuration (when the puncturing configuration indicates RB-level puncturing). In some aspects, RB-level puncturing may be applied when PDCCH precoding is performed across REGs, which enables an REG-bundle to be partially punctured, as shown in the left diagram of FIG. 5B. The right diagram in FIG. 5B illustrates an example of REG-bundle-level puncturing. As shown in the right diagram, an REG-bundle with index 7 in RB index 14 and 15 is partially outside of the transmission bandwidth and, therefore, may be punctured according to the puncturing configuration (when the puncturing configuration indicates REG-bundle-level puncturing). In some aspects, if REG-bundle-level puncturing is applied, then a total quantity of RBs after puncturing is an integer number of REG-bundles.

In some aspects, the puncturing configuration may indicate one or more parameters based at least in part on which the CORESET is punctured. For example, the puncturing configuration may indicate a quantity of RBs in the frequency domain allocated for the CORESET. As another example, the puncturing configuration may indicate an index of one or more punctured RBs in the frequency domain. As another example, the puncturing configuration may indicate a quantity of PDCCH symbols in the CORESET. As another example, the puncturing configuration may indicate an REG-bundle size associated with the CORESET. As another example, the puncturing configuration may indicate a PDCCH precoding configuration associated with the CORESET. As another example, the puncturing configuration may indicate whether the CORESET is to be interleaved or non-interleaved. Thus, in some aspects, a manner in which the CORESET is to be punctured may depend on, for example, a quantity of PDCCH symbols in the CORESET, an REG-bundle size, or a PDCCH precoding configuration, among other examples.

FIG. 5C is an example of a table associated with indication of the puncturing configuration. In the example shown in FIG. 5C, each row corresponds to a set of parameters for a different puncturing configuration. Here, the network node 110 may indicate the puncturing configuration to the UE 120 by transmitting an indication of a puncturing configuration index corresponding to a puncturing configuration to be applied to a CORESET to be communicated in the transmission bandwidth.

In some aspects, a frequency resource allocation granularity associated with the CORESET may be smaller than 6 RBs in the frequency domain, and may be a greatest common factor with a quantity of RBs in the frequency domain in the CORESET. For example, a frequency resource allocation granularity (e.g., an RB group) for the CORESET may be smaller than 6 RBs, and may be set as the greatest common factor of a CORESET with less than 5 MHz (e.g., 1 RB for a CORESET with a size of 15 RBs or 16 RBs).

As shown in FIG. 5A at reference 504, the network node 110 may transmit, and the UE 120 may receive, the CORESET in the transmission bandwidth based at least in part on the puncturing configuration.

In some aspects, when transmitting the CORESET, the network node 110 may transmit with zero power in an RB or an REG-bundle that is at least partially outside of the transmission bandwidth. For example, the network node 110 may apply legacy CCE-to-REG mapping, but may zero out transmission power for the punctured RB or the REG-bundle.

In some aspects, in association with transmitting the CORESET, the network node 110 may apply PDCCH precoding across all REGs of the CORESET in association with applying resource-block-level puncturing. Thus, in some aspects, puncturing may be based at least in part on PDCCH precoding across all REGs. In some aspects, example, for legacy CORESET 0, precoding is within an REG bundle, but for CORESET 0 with a transmission bandwidth of less than 5 MHz, the network node 110 may apply precoding across all REGs (e.g., to reduce a quantity of punctured RBs). In some aspects, if a PDCCH precoding is to be applied across all REGs (e.g., if a precoder granularity is set to allContiguousRBs), then the same precoding is used across all the REGs in the CORESET and RB-level puncturing is supported.

Alternatively, in association with transmitting the CORESET, the network node 110 may in some aspects apply PDCCH precoding within each REG of the CORESET in association with applying REG-bundle-level puncturing. Thus, in some aspects, puncturing may be based at least in part on PDCCH precoding within each REG-bundle. In some aspects, if PDCCH precoding is applied within each REG-bundle (e.g., if a precoder granularity is set to sameAsREG-bundle), then the same precoding is used with an REG-bundle and REG-bundling-level puncturing is supported (e.g., when partial REG-bundle precoding is not permitted).

In some aspects, in association with receiving the CORESET, the UE 120 may perform PDCCH detection within a search space, and may set a log-likelihood ratio (LLR) of an RB or an REG-bundle that is at least partially outside of the transmission bandwidth to zero. That is, when performing PDCCH detection in association with receiving the CORESET, the UE 120 may in some aspects zero out the one or more punctured RBs or REG-bundles. In such an aspect, the UE 120 may perform decoding as if no RB is punctured.

In some aspects, in association with receiving the CORESET, the UE 120 may perform PDCCH channel estimation, and a DMRS within an RB or an REG-bundle that is at least partially outside of the transmission bandwidth is ignored. That is, when performing PDCCH channel estimation in association with receiving the CORESET, the UE 120 may in some aspects ignore a DMRS within a punctured RB or REG-bundle. However, if PDCCH precoding is applied within each REG-bundle, then the UE 120 may in some aspects process the DMRS within the same REG-bundle together (and partial DMRS channel estimation may be not supported).

In some aspects, the network node 110 may enable one or more AL candidates based at least in part on a code rate after puncturing. Here, the code rate may depend on a ratio of punctured RB(s) or REG-bundle(s) to a total quantity of RBs or REG-bundles in the CORESET. An AL candidate is a PDCCH candidate associated with a given AL, with the PDCCH candidate being a set of resources in which the UE 120 is to perform blind decoding in association with receiving the CORESET. Here, a comparatively larger ratio of punctured RBs or REG-bundles for a given AL candidate would degrade PDCCH performance. Thus, the PDCCH loss due to puncturing may need to be controlled. For example, if a puncturing threshold of 15% is used (e.g., 15% of a total quantity of RBs or REG-bundles), then RB-level puncturing for an AL candidate associated with AL of 4 or 8 with 1 RB punctured, or for an AL candidate associated with an AL of 8 with 1 REG-bundle punctured, may be enabled. Conversely, for puncturing that exceeds the puncturing threshold, an AL may not be enabled. For example, if a puncturing threshold of 15% is used, then RB-level puncturing for an AL candidate associated with an AL of 2 or 1 with 1 RB punctured, or for an AL candidate associated with an AL of 4 or 2 with 1 REG-bundle punctured, may not be enabled.

In some aspects, whether to enable a given AL candidate for the CORESET with one or more punctured RBs or REG-bundles may be determined based at least in part on a CORESET configuration, a search space set configuration, or using RRC signaling. For example, for a PDCCH in CORESET 0 or in a common search space (CSS), enabled AL candidates for the CORESET with one or more punctured RBs or REG-bundles can be predefined (e.g., preconfigured on the network node 110 or the UE 120). As another example, for a PDCCH in a UE-specific search space (USS) for an RRC-connected UE 120, enabled AL candidates for the CORESET with one or more punctured RBs or REG-bundles may be determined by the network node 110 and configured on the UE 120 via, for example, a unicast RRC communication. Thus, in some aspects, the network node 110 or the UE 120 may determine one or more enabled AL candidates associated with transmitting/receiving the CORESET. In some aspects, the network node 110 may transmit the CORESET based at least in part on an enabled AL candidate of the one or more enabled AL candidates. The UE 120, in association with receiving the CORESET, may perform blind decoding on one or more PDCCH candidates associated with the one or more enabled AL candidates.

In some aspects, a quantity of PDCCH candidates per enabled AL candidate is based at least in part on a quantity of RBs (e.g., in a frequency domain) in the CORESET, the quantity of PDCCH symbols in the CORESET, or the REG-bundle size associated with the CORESET. That is, a quantity of PDCCH candidates per AL can in some aspects be adjusted based on the quantity of RBs in the CORESET, a quantity of symbols in the CORESET, or the REG-bundle size. In some aspects, a quantity of PDCCH candidates per enabled AL candidate for one or more enabled AL candidates is based at least in part on a quantity of CCEs of the CORESET before puncturing. FIG. 5D is an example of a table associated with determination of the quantity of the CCEs in the CORESET and the corresponding enabled AL candidates. The number of CCEs N_{CCE} is equal to the quantity of RBs times a quantity of symbols in the CORESET and divided by 6. The maximum number of PDCCH candidates per AL is equal to └N_{CCE}/AL┘. In the example shown in FIG. 5D, each row corresponds to a set of parameters associated with a different set of enabled AL candidates. In some aspects, the network node 110 or the UE 120 may be configured with a table such as that shown in FIG. 5D in order to enable determination of enabled AL candidates associated with transmission of a given CORESET.

In some aspects, the network node 110 may transmit, and the UE 120 may receive, an indication of an AL that is to be applied in association with communicating the CORESET. For example, an AL that enables the CCE to be mapped within the transmission bandwidth may be supported. As one example, as illustrated in FIG. 5E, an AL of 7 may be used (e.g., rather than an AL of 8). In some aspects, whether to support such an AL may be depend on a ratio of CCEs that fall outside of the transmission bandwidth. For example, an AL of 3 may not be supported because 25% of CCEs would be punctured. In some such aspects, in association with transmitting the CORESET, the network node 110 may transmit the CORESET based at least in part on the indicated AL. The UE 120 may, in association with receiving the CORESET, perform blind decoding for one or more PDCCH candidates associated with the indicated AL.

As indicated above, FIGS. 5A-5E are provided as examples. Other examples may differ from what is described with respect to FIG. 5A-5E.

FIG. 6 is a diagram illustrating an example process 600 performed, for example, by a UE, in accordance with the present disclosure. Example process 600 is an example where the UE (e.g., UE 120) performs operations associated with CORESET and PDCCH puncturing.

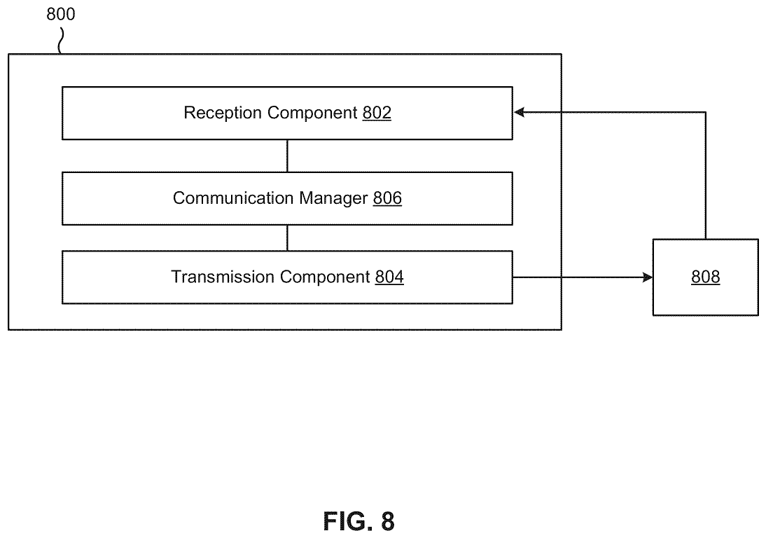

As shown in FIG. 6, in some aspects, process 600 may include receiving a CORESET configuration indicating puncturing associated with a CORESET to be received in a transmission bandwidth, wherein the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET (block 610). For example, the UE (e.g., using reception component 802 and/or communication manager 806, depicted in FIG. 8) may receive a CORESET configuration indicating puncturing associated with a CORESET to be received in a transmission bandwidth, wherein the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET, as described above.

As further shown in FIG. 6, in some aspects, process 600 may include receiving the CORESET in the transmission bandwidth based at least in part on the puncturing indicated by the CORESET configuration (block 620). For example, the UE (e.g., using reception component 802 and/or communication manager 806, depicted in FIG. 8) may receive the CORESET in the transmission bandwidth based at least in part on the puncturing indicated by the CORESET configuration, as described above.

Process 600 may include additional aspects, such as any single aspect or any combination of aspects described below and/or in connection with one or more other processes described elsewhere herein.

In a first aspect, the puncturing indicates that resource-block level puncturing is to be applied to the CORESET.

In a second aspect, alone or in combination with the first aspect, the puncturing indicates that REG-bundle-level puncturing is to be applied to the CORESET.

In a third aspect, alone or in combination with one or more of the first and second aspects, a configured quantity of RBs in a frequency domain in the CORESET is greater than a quantity of RBs in the transmission bandwidth, and an RB or an REG-bundle of the CORESET that is at least partially outside of the transmission bandwidth is punctured.

In a fourth aspect, alone or in combination with one or more of the first through third aspects, receiving the CORESET comprises performing PDCCH detection within a search space, wherein an LLR of a resource block or an REG-bundle that is at least partially outside of the transmission bandwidth is set to zero.

In a fifth aspect, alone or in combination with one or more of the first through fourth aspects, receiving the CORESET comprises performing PDCCH channel estimation, and a demodulation reference signal within a resource block or an REG-bundle that is at least partially outside of the transmission bandwidth is ignored.

In a sixth aspect, alone or in combination with one or more of the first through fifth aspects, a frequency resource allocation granularity associated with the CORESET is smaller than 6 RBs in a frequency domain and is a greatest common factor with a quantity of RBs in the frequency domain in the CORESET.

In a seventh aspect, alone or in combination with one or more of the first through sixth aspects, process 600 includes determining one or more enabled aggregation level candidates associated with receiving the CORESET, wherein receiving the CORESET comprises performing blind decoding on one or more PDCCH candidates associated with the one or more enabled aggregation level candidates.

In an eighth aspect, alone or in combination with one or more of the first through seventh aspects, the one or more enabled aggregation level candidates are determined based at least in part on the CORESET configuration, a search space set configuration, or an indication received via radio resource control signaling.

In a ninth aspect, alone or in combination with one or more of the first through eighth aspects, a quantity of PDCCH candidates per enabled aggregation level candidate for one or more enabled aggregation level candidates associated with receiving the CORESET is based at least in part on at least one of a quantity of resource blocks in a frequency domain in the CORESET, the quantity of PDCCH symbols in the CORESET, or the REG-bundle size associated with the CORESET.

In a tenth aspect, alone or in combination with one or more of the first through ninth aspects, process 600 includes receiving an indication of an aggregation level that is to be applied in association with receiving the CORESET, wherein receiving the CORESET comprises performing blind decoding for one or more PDCCH candidates associated with the aggregation level.

In an eleventh aspect, alone or in combination with one or more of the first through tenth aspects, a quantity of PDCCH candidates per enabled aggregation level candidate for one or more enabled aggregation level candidates associated with receiving the CORESET is based at least in part on a quantity of CCEs of the CORESET before puncturing.

In a twelfth aspect, alone or in combination with one or more of the first through eleventh aspects, the CORESET configuration indicates whether the CORESET is to be interleaved or non-interleaved.

In a thirteenth aspect, alone or in combination with one or more of the first through twelfth aspects, PDCCH precoding within each REG of the CORESET is applied in association with REG-bundle-level puncturing.

In a fourteenth aspect, alone or in combination with one or more of the first through thirteenth aspects, the CORESET is CORESET 0.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with CORESET and PDCCH puncturing.

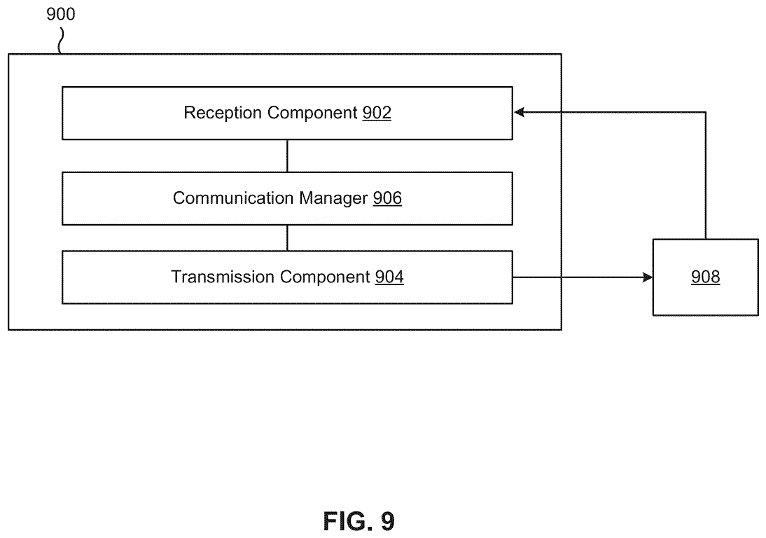

As shown in FIG. 7, in some aspects, process 700 may include transmitting a CORESET configuration indicating puncturing associated with a CORESET to be received in a transmission bandwidth, wherein the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET (block 710). For example, the network node (e.g., using transmission component 904 and/or communication manager 906, depicted in FIG. 9) may transmit a CORESET configuration indicating puncturing associated with a CORESET to be received in a transmission bandwidth, wherein the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET, as described above.

As further shown in FIG. 7, in some aspects, process 700 may include transmitting the CORESET in the transmission bandwidth based at least in part on the puncturing indicated by the CORESET configuration (block 720). For example, the network node (e.g., using transmission component 904 and/or communication manager 906, depicted in FIG. 9) may transmit the CORESET in the transmission bandwidth based at least in part on the puncturing indicated by the CORESET configuration, as described above.

Process 700 may include additional aspects, such as any single aspect or any combination of aspects described below and/or in connection with one or more other processes described elsewhere herein.

In a first aspect, the puncturing indicates that resource-block-level puncturing is to be applied to the CORESET.

In a second aspect, alone or in combination with the first aspect, the puncturing indicates that REG-bundle-level puncturing is to be applied to the CORESET.

In a third aspect, alone or in combination with one or more of the first and second aspects, a configured quantity of RBs in a frequency domain in the CORESET is greater than a quantity of RBs in the transmission bandwidth, and an RB or an REG-bundle of the CORESET that is at least partially outside of the transmission bandwidth is punctured.

In a fourth aspect, alone or in combination with one or more of the first through third aspects, transmitting the CORESET comprises transmitting with zero power in a resource block or an REG-bundle that is at least partially outside of the transmission bandwidth.

In a fifth aspect, alone or in combination with one or more of the first through fourth aspects, transmitting the CORESET comprises applying PDCCH precoding across all REGs of the CORESET in association with applying resource-block-level puncturing.

In a sixth aspect, alone or in combination with one or more of the first through fifth aspects, transmitting the CORESET comprises applying PDCCH precoding within each REG of the CORESET in association with applying REG-bundle-level puncturing.

In a seventh aspect, alone or in combination with one or more of the first through sixth aspects, a frequency resource allocation granularity associated with the CORESET is smaller than 6 RBs in a frequency domain and is a greatest common factor with a quantity of RBs in the frequency domain in the CORESET.

In an eighth aspect, alone or in combination with one or more of the first through seventh aspects, process 700 includes determining one or more enabled aggregation level candidates associated with transmitting the CORESET, wherein the CORESET is transmitted based at least in part on an enabled aggregation level candidate of the one or more enabled aggregation level candidates.

In a ninth aspect, alone or in combination with one or more of the first through eighth aspects, the one or more enabled aggregation level candidates are determined based at least in part on the CORESET configuration, a search space set configuration, or an indication transmitted via radio resource control signaling.

In a tenth aspect, alone or in combination with one or more of the first through ninth aspects, a quantity of PDCCH candidates per enabled aggregation level candidate for one or more enabled aggregation level candidates associated with receiving the CORESET is based at least in part on at least one of a quantity of resource blocks in a frequency domain in the CORESET, the quantity of PDCCH symbols in the CORESET, or the REG-bundle size associated with the CORESET.

In an eleventh aspect, alone or in combination with one or more of the first through tenth aspects, process 700 includes transmitting an indication of an aggregation level that is to be applied in association with transmitting the CORESET, wherein the CORESET is transmitted based at least in part on the aggregation level.

In a twelfth aspect, alone or in combination with one or more of the first through eleventh aspects, a quantity of PDCCH candidates per enabled aggregation level candidate for one or more enabled aggregation level candidates associated with transmitting the CORESET is based at least in part on a quantity of CCEs of the CORESET before puncturing.

In a thirteenth aspect, alone or in combination with one or more of the first through twelfth aspects, the CORESET configuration indicates whether the CORESET is interleaved or is non-interleaved.

In a fourteenth aspect, alone or in combination with one or more of the first through thirteenth aspects, the CORESET is CORESET 0.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 5A-5E. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive a CORESET configuration indicating puncturing associated with a CORESET to be received in a transmission bandwidth wherein the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET. The reception component 802 may receive the CORESET in the transmission bandwidth based at least in part on the puncturing indicated by the CORESET configuration.

The communication manager 806 may determine one or more enabled aggregation level candidates associated with receiving the CORESET, wherein receiving the CORESET comprises performing blind decoding on one or more PDCCH candidates associated with the one or more enabled aggregation level candidates.

The reception component 802 may receive an indication of an aggregation level that is to be applied in association with receiving the CORESET, wherein receiving the CORESET comprises performing blind decoding for one or more PDCCH candidates associated with the aggregation level.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 5A-5E. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit a CORESET configuration indicating puncturing associated with a CORESET to be received in a transmission bandwidth, wherein the puncturing indicates at least one of a quantity of RBs in a frequency domain allocated for the CORESET, an index of one or more punctured RBs in the frequency domain, a quantity of PDCCH symbols in the CORESET, an REG-bundle size associated with the CORESET, or a PDCCH precoding configuration associated with the CORESET. The transmission component 904 may transmit the CORESET in the transmission bandwidth based at least in part on the puncturing indicated by the CORESET configuration.

The communication manager 906 may determine one or more enabled aggregation level candidates associated with transmitting the CORESET, wherein the CORESET is transmitted based at least in part on an enabled aggregation level candidate of the one or more enabled aggregation level candidates.

The transmission component 904 may transmit an indication of an aggregation level that is to be applied in association with transmitting the CORESET, wherein the CORESET is transmitted based at least in part on the aggregation level.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: receiving a control resource set (CORESET) configuration indicating puncturing associated with a CORESET to be received in a transmission bandwidth, wherein the puncturing indicates at least one of a quantity of resource blocks in a frequency domain allocated for the CORESET, an index of one or more punctured resource blocks in the frequency domain, a quantity of physical downlink control channel (PDCCH) symbols in the CORESET, a resource element group (REG)-bundle size associated with the CORESET, or a PDCCH precoding configuration associated with the CORESET; and receiving the CORESET in the transmission bandwidth based at least in part on the puncturing indicated by the CORESET configuration.
Aspect 2: The method of Aspect 1, wherein the puncturing indicates that resource-block level puncturing is to be applied to the CORESET.
Aspect 3: The method of any of Aspects 1-2, wherein the puncturing indicates that REG-bundle-level puncturing is to be applied to the CORESET.
Aspect 4: The method of any of Aspects 1-3, wherein a configured quantity of resource blocks (RBs) in a frequency domain in the CORESET is greater than a quantity of RBs in the transmission bandwidth, and an RB or an REG-bundle of the CORESET that is at least partially outside of the transmission bandwidth is punctured.
Aspect 5: The method of any of Aspects 1-4, wherein receiving the CORESET comprises performing PDCCH detection within a search space, wherein a log-likelihood ratio (LLR) of a resource block or an REG-bundle that is at least partially outside of the transmission bandwidth is set to zero.
Aspect 6: The method of any of Aspects 1-5, wherein receiving the CORESET comprises performing PDCCH channel estimation, and wherein a demodulation reference signal within a resource block or an REG-bundle that is at least partially outside of the transmission bandwidth is ignored.
Aspect 7: The method of any of Aspects 1-6, wherein a frequency resource allocation granularity associated with the CORESET is smaller than 6 resource blocks (RBs) in a frequency domain and is a greatest common factor with a quantity of RBs in the frequency domain in the CORESET.
Aspect 8: The method of any of Aspects 1-7, further comprising determining one or more enabled aggregation level candidates associated with receiving the CORESET, wherein receiving the CORESET comprises performing blind decoding on one or more PDCCH candidates associated with the one or more enabled aggregation level candidates.
Aspect 9: The method of Aspect 8, wherein the one or more enabled aggregation level candidates are determined based at least in part on a CORESET configuration, a search space set configuration, or an indication received via radio resource control signaling.
Aspect 10: The method of any of Aspects 1-9, wherein a quantity of PDCCH candidates per enabled aggregation level candidate for one or more enabled aggregation level candidates associated with receiving the CORESET is based at least in part on at least one of a quantity of resource blocks in a frequency domain in the CORESET, the quantity of PDCCH symbols in the CORESET, or the REG-bundle size associated with the CORESET.
Aspect 11: The method of any of Aspects 1-10, further comprising receiving an indication of an aggregation level that is to be applied in association with receiving the CORESET, wherein receiving the CORESET comprises performing blind decoding for one or more PDCCH candidates associated with the aggregation level.
Aspect 12: The method of any of Aspects 1-11, wherein a quantity of PDCCH candidates per enabled aggregation level candidate for one or more enabled aggregation level candidates associated with receiving the CORESET is based at least in part on a quantity of control channel elements (CCEs) of the CORESET before puncturing.
Aspect 13: The method of any of Aspects 1-12, wherein the CORESET configuration indicates whether the CORESET is to be interleaved or non-interleaved.
Aspect 14: The method of any of Aspects 1-13, wherein PDCCH precoding within each REG of the CORESET is applied in association with REG-bundle-level puncturing.
Aspect 15: The method of any of Aspects 1-14, wherein the CORESET is CORESET 0.
Aspect 16: A method of wireless communication performed by a network node, comprising: transmitting a control resource set (CORESET) configuration indicating puncturing associated with a CORESET to be received in a transmission bandwidth, wherein the puncturing indicates at least one of a quantity of resource blocks in a frequency domain allocated for the CORESET, an index of one or more punctured resource blocks in the frequency domain, a quantity of physical downlink control channel (PDCCH) symbols in the CORESET, a resource element group (REG)-bundle size associated with the CORESET, or a PDCCH precoding configuration associated with the CORESET; and transmitting the CORESET in the transmission bandwidth based at least in part on the puncturing indicated by the CORESET configuration.
Aspect 17: The method of Aspect 16, wherein the puncturing indicates that resource-block-level puncturing is to be applied to the CORESET.
Aspect 18: The method of any of Aspects 16-17, wherein the puncturing indicates that REG-bundle-level puncturing is to be applied to the CORESET.
Aspect 19: The method of any of Aspects 16-18, wherein a configured quantity of resource blocks (RBs) in a frequency domain in the CORESET is greater than a quantity of RBs in the transmission bandwidth, and an RB or an REG-bundle of the CORESET that is at least partially outside of the transmission bandwidth is punctured.
Aspect 20: The method of any of Aspects 16-19, wherein transmitting the CORESET comprises transmitting with zero power in a resource block or an REG-bundle that is at least partially outside of the transmission bandwidth.
Aspect 21: The method of any of Aspects 16-20, wherein transmitting the CORESET comprises applying PDCCH precoding across all REGs of the CORESET in association with applying resource-block-level puncturing.
Aspect 22: The method of any of Aspects 16-21, wherein transmitting the CORESET comprises applying PDCCH precoding within each REG of the CORESET in association with applying REG-bundle-level puncturing.
Aspect 23: The method of any of Aspects 16-22, wherein a frequency resource allocation granularity associated with the CORESET is smaller than 6 resource blocks (RBs) in a frequency domain and is a greatest common factor with a quantity of RBs in the frequency domain in the CORESET.
Aspect 24: The method of any of Aspects 16-23, further comprising determining one or more enabled aggregation level candidates associated with transmitting the CORESET, wherein the CORESET is transmitted based at least in part on an enabled aggregation level candidate of the one or more enabled aggregation level candidates.
Aspect 25: The method of Aspect 24, wherein the one or more enabled aggregation level candidates are determined based at least in part on a CORESET configuration, a search space set configuration, or an indication transmitted via radio resource control signaling.
Aspect 26: The method of Aspect any of aspects 16-25, wherein a quantity of PDCCH candidates per enabled aggregation level candidate for one or more enabled aggregation level candidates associated with receiving the CORESET is based at least in part on at least one of a quantity of resource blocks in a frequency domain in the CORESET, the quantity of PDCCH symbols in the CORESET, or the REG-bundle size associated with the CORESET.
Aspect 27: The method of any of Aspects 16-26, further comprising transmitting an indication of an aggregation level that is to be applied in association with transmitting the CORESET, wherein the CORESET is transmitted based at least in part on the aggregation level.
Aspect 28: The method of any of Aspects 16-27, wherein a quantity of PDCCH candidates per enabled aggregation level candidate for one or more enabled aggregation level candidates associated with transmitting the CORESET is based at least in part on a quantity of control channel elements (CCEs) of the CORESET before puncturing.
Aspect 29: The method of any of Aspects 16-28, wherein the CORESET configuration indicates whether the CORESET is interleaved or is non-interleaved.
Aspect 30: The method of any of Aspects 16-29, wherein the CORESET is CORESET 0.
Aspect 31: An apparatus for wireless communication at a device, comprising a processor; one or more memories coupled with the processor; and instructions stored in the one or more memories and executable by the processor to cause the apparatus to perform the method of one or more of Aspects 1-30.
Aspect 32: A device for wireless communication, comprising one or more memories and one or more processors coupled to the one or more memories, the one or more processors configured to perform the method of one or more of Aspects 1-30.
Aspect 33: An apparatus for wireless communication, comprising at least one means for performing the method of one or more of Aspects 1-30.
Aspect 34: A non-transitory computer-readable medium storing code for wireless communication, the code comprising instructions executable by a processor to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
receive a control resource set (CORESET) configuration indicating puncturing associated with a CORESET to be received in a transmission bandwidth,
wherein the puncturing indicates at least one of a quantity of resource blocks in a frequency domain allocated for the CORESET, an index of one or more punctured resource blocks in the frequency domain, a quantity of physical downlink control channel (PDCCH) symbols in the CORESET, a resource element group (REG)-bundle size associated with the CORESET, or a PDCCH precoding configuration associated with the CORESET; and
receive the CORESET in the transmission bandwidth based at least in part on the puncturing indicated by the CORESET configuration.

2. The UE of claim 1, wherein the puncturing indicates that resource-block level puncturing is to be applied to the CORESET.

3. The UE of claim 1, wherein the puncturing indicates that REG-bundle-level puncturing is to be applied to the CORESET.

4. The UE of claim 1, wherein a configured quantity of resource blocks (RBs) in a frequency domain in the CORESET is greater than a quantity of RBs in the transmission bandwidth, and an RB or an REG-bundle of the CORESET that is at least partially outside of the transmission bandwidth is punctured.

5. The UE of claim 1, wherein receiving the CORESET comprises performing PDCCH detection within a search space, wherein a log-likelihood ratio (LLR) of a resource block or an REG-bundle that is at least partially outside of the transmission bandwidth is set to zero.

6. The UE of claim 1, wherein receiving the CORESET comprises performing PDCCH channel estimation, and wherein a demodulation reference signal within a resource block or an REG-bundle that is at least partially outside of the transmission bandwidth is ignored.

7. The UE of claim 1, wherein the one or more processors are further configured to determine one or more enabled aggregation level candidates associated with receiving the CORESET, wherein receiving the CORESET comprises performing blind decoding on one or more PDCCH candidates associated with the one or more enabled aggregation level candidates.

8. The UE of claim 7, wherein the one or more enabled aggregation level candidates are determined based at least in part on the CORESET configuration, a search space set configuration, or an indication received via radio resource control signaling.

9. The UE of claim 1, wherein a quantity of PDCCH candidates per enabled aggregation level candidate for one or more enabled aggregation level candidates associated with receiving the CORESET is based at least in part on at least one of a quantity of resource blocks in a frequency domain in the CORESET, the quantity of PDCCH symbols in the CORESET, or the REG-bundle size associated with the CORESET.

10. The UE of claim 1, wherein a quantity of PDCCH candidates per enabled aggregation level candidate for one or more enabled aggregation level candidates associated with receiving the CORESET is based at least in part on a quantity of control channel elements (CCEs) of the CORESET before puncturing.

11. The UE of claim 1, wherein the CORESET configuration indicates whether the CORESET is to be interleaved or non-interleaved.

12. The UE of claim 1, wherein PDCCH precoding within each REG of the CORESET is applied in association with REG-bundle-level puncturing.

13. The UE of claim 1, wherein the CORESET is CORESET 0.

14. A network node for wireless communication, comprising:
one or more memories; and
one or more processors, coupled to the one or more memories, configured to:
transmit a control resource set (CORESET) configuration indicating puncturing associated with a CORESET to be received in a transmission bandwidth,
wherein the puncturing indicates at least one of a quantity of resource blocks in a frequency domain allocated for the CORESET, an index of one or more punctured resource blocks in the frequency domain, a quantity of physical downlink control channel (PDCCH) symbols in the CORESET, a resource element group (REG)-bundle size associated with the CORESET, or a PDCCH precoding configuration associated with the CORESET; and
transmit the CORESET in the transmission bandwidth based at least in part on the puncturing indicated by the CORESET configuration.

15. The network node of claim 14, wherein the puncturing indicates that resource-block-level puncturing is to be applied to the CORESET.

16. The network node of claim 14, wherein the puncturing indicates that REG-bundle-level puncturing is to be applied to the CORESET.

17. The network node of claim 14, wherein a configured quantity of resource blocks (RBs) in a frequency domain in the CORESET is greater than a quantity of RBs in the transmission bandwidth, and an RB or an REG-bundle of the CORESET that is at least partially outside of the transmission bandwidth is punctured.

18. The network node of claim 14, wherein the one or more processors, to transmit the CORESET, are configured to transmit with zero power in a resource block or an REG-bundle that is at least partially outside of the transmission bandwidth.

19. The network node of claim 14, wherein the one or more processors, to transmit the CORESET, are configured to apply PDCCH precoding across all REGs of the CORESET in association with applying resource-block-level puncturing.

20. The network node of claim 14, wherein the one or more processors, to transmit the CORESET, are configured to apply PDCCH precoding within each REG of the CORESET in association with applying REG-bundle-level puncturing.

21. The network node of claim 14, wherein the one or more processors are further configured to determine one or more enabled aggregation level candidates associated with transmitting the CORESET, wherein the CORESET is transmitted based at least in part on an enabled aggregation level candidate of the one or more enabled aggregation level candidates.

22. The network node of claim 21, wherein the one or more enabled aggregation level candidates are determined based at least in part on a CORESET configuration, a search space set configuration, or an indication transmitted via radio resource control signaling.

23. The network node of claim 14, wherein a quantity of PDCCH candidates per enabled aggregation level candidate for one or more enabled aggregation level candidates associated with transmitting the CORESET is based at least in part on at least one of a quantity of resource blocks in a frequency domain in the CORESET, the quantity of PDCCH symbols in the CORESET, or the REG-bundle size associated with the CORESET.

24. The network node of claim 14, wherein a quantity of PDCCH candidates per enabled aggregation level candidate for one or more enabled aggregation level candidates associated with transmitting the CORESET is based at least in part on a quantity of control channel elements (CCEs) of the CORESET before puncturing.

25. The network node of claim 14, wherein the CORESET configuration indicates whether the CORESET is interleaved or is non-interleaved.

26. The network node of claim 14, wherein the CORESET is CORESET 0.

27. A method of wireless communication performed by a user equipment (UE), comprising:
receiving a control resource set (CORESET) configuration indicating puncturing associated with a CORESET to be received in a transmission bandwidth,
wherein the puncturing indicates at least one of a quantity of resource blocks in a frequency domain allocated for the CORESET, an index of one or more punctured resource blocks in the frequency domain, a quantity of physical downlink control channel (PDCCH) symbols in the CORESET, a resource element group (REG)-bundle size associated with the CORESET, or a PDCCH precoding configuration associated with the CORESET; and
receiving the CORESET in the transmission bandwidth based at least in part on the puncturing indicated by the CORESET configuration.

28. The method of claim 27, wherein the puncturing indicates that resource-block level puncturing is to be applied to the CORESET.

29. A method of wireless communication performed by a network node, comprising:
transmitting a control resource set (CORESET) configuration indicating puncturing associated with a CORESET to be received in a transmission bandwidth,
wherein the puncturing indicates at least one of a quantity of resource blocks in a frequency domain allocated for the CORESET, an index of one or more punctured resource blocks in the frequency domain, a quantity of physical downlink control channel (PDCCH) symbols in the CORESET, a resource element group (REG)-bundle size associated with the CORESET, or a PDCCH precoding configuration associated with the CORESET; and
transmitting the CORESET in the transmission bandwidth based at least in part on the puncturing indicated by the CORESET configuration.

30. The method of claim 29, wherein the puncturing indicates that resource-block-level puncturing is to be applied to the CORESET.
